(19) United States
(12) Patent Application Publication
(10) Pub. No.: US 2002/0123575 A1
(43) Pub. Date: Sep. 5, 2002

(54) Resin composite material

(75) Inventors: Makoto Kato, Aichi-gun (JP); Arimitsu Usuki, Aichi-gun (JP); Junji Shirai, Kariya-shi (JP); Hiroyuki Wakabayashi, Kariya-shi (JP); Kazutoyo Osuka, Gamagori-shi (JP); Sho Sato, Utsunomiya-shi (JP); Takuro Kitamura, Moka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOYOTA CHUO KENKYUSHO, Aichi-gun (JP)

(21) Appl. No.: 10/026,627

(22) Filed: Dec. 27, 2001

(30) Foreign Application Priority Data
Dec. 28, 2000 (JP) 2000-399890

(51) Int. Cl. C08G 65/48

(52) U.S. Cl. 525/390

(57) ABSTRACT

A resin composite material according to the present invention contains a thermoplastic resin composition containing a polyphenylene oxide, a layered clay mineral dispersed in the thermoplastic resin composition and organized with an organizing agent, and a polar compound dispersed in the thermoplastic resin composition and chemically bonded to the layered clay mineral. The layered clay mineral is satisfactorily uniformly dispersed in the thermoplastic resin composition even after kneading under high temperature conditions. The resin composite material has adequately enhanced characteristics of mechanical strength, durability, and so on.

### BACKGROUND OF THE INVENTION

1. Field of the Invention

The present invention relates to a resin composite material and, more particularly, to a resin composite material containing an organized, layered clay mineral.

2. Related Background Art

For improving characteristics, such as mechanical strength, durability (fatigue life), and so on, of a thermoplastic resin, a method that has been employed heretofore is to add a layered clay mineral such as kaolinite or montmorillonite to the thermoplastic resin. Concerning this method, it is known that dispersibility of the layered clay mineral in the thermoplastic resin can be improved by adding the layered clay mineral organized with an organizing agent, rather than by adding the layered clay mineral as it is.

Some resin composite materials obtained by the method of adding the layered clay mineral organized with the organizing agent, to the thermoplastic resin in this way are disclosed, for example, in Japanese Patent Application Laid-Open No. H09-217012. This Application describes that the layered clay mineral can be finely dispersed in the thermoplastic resin when the layered clay mineral in which an organic material (organizing agent) having an onium ion is intercalated between layers, is added to the thermoplastic resin.

In addition, Japanese Patent Application Laid-Open No. H10-1608 discloses resin composite materials obtained by a method of adding to a polyamide resin a layered silicate in which a quaternary onium ion having a hydrocarbon chain of eight or more carbons (as an organizing agent) is intercalated.

### SUMMARY OF THE INVENTION

Incidentally, where a thermoplastic resin composition containing polyphenylene oxide was used as a raw material for a resin composite material, it was necessary to add the layered clay mineral organized with the organizing agent, to the thermoplastic resin composition and knead them under high temperature conditions, in order to uniformly disperse the layered clay mineral in the thermoplastic resin composition. However, the kneading under such severe conditions shortened the layer-to-layer (interlayer) distance between layers of the layered clay mineral because of thermal decomposition of the organizing agent, so as to fail in satisfactorily uniformly dispersing the layered clay mineral, which resulted in failing to adequately enhance the characteristics of mechanical strength, durability, and so on.

The present invention has been accomplished in view of the problem in the foregoing related arts, and an object of the present invention is to provide a resin composite material that comprises a layered clay mineral and a thermoplastic resin composition comprising a polyphenylene oxide, wherein the layered clay mineral is satisfactorily uniformly dispersed in the thermoplastic resin composition even after the kneading under high temperature conditions, the resin composite material being provided with adequately enhanced characteristics of mechanical strength, durability, and so on, and also to provide a method of producing the resin composite material.

The inventors have conducted elaborate research in order to accomplish the above object and found that the above problem was solved when the layered clay mineral organized with the organizing agent, and a polar compound were added to the thermoplastic resin composition comprising the polyphenylene oxide so as to form a chemical bond between the layered clay mineral and the polar compound in the thermoplastic resin composition, thus completing the present invention.

Namely, a resin composite material of the present invention comprises:

a thermoplastic resin composition comprising a polyphenylene oxide;

a layered clay mineral dispersed in the thermoplastic resin composition and organized with an organizing agent; and

a polar compound dispersed in the thermoplastic resin composition and chemically bonded to the layered clay mineral.

A first production method of a resin composite material according to the present invention is a method of producing a resin composite material comprising a thermoplastic resin composition comprising a polyphenylene oxide, a layered clay mineral dispersed in the thermoplastic resin composition and organized with an organizing agent, and a polar compound dispersed in the thermoplastic resin composition and chemically bonded to the layered clay mineral, said method comprising:

a step of dispersing the polar compound in the thermoplastic resin composition comprising the polyphenylene oxide, to obtain a mixture of the thermoplastic resin composition and the polar compound; and

a step of dispersing the layered clay mineral organized with the organizing agent, in the mixture to obtain the resin composite material.

Further, a second production method of a resin composite material according to the present invention is a method of producing a resin composite material comprising a thermoplastic resin composition comprising a polyphenylene oxide, a layered clay mineral dispersed in the thermoplastic resin composition and organized with an organizing agent, and a polar compound dispersed in the thermoplastic resin composition and chemically bonded to the layered clay mineral, said method comprising:

a step of mixing the polar compound and the layered clay mineral organized with the organizing agent, to obtain a complex in which the layered clay mineral and the polar compound are chemically bonded to each other between layers of the layered clay mineral; and

a step of dispersing the complex in the thermoplastic resin composition comprising the polyphenylene oxide, to obtain the resin composite material.

According to the present invention, the polar compound, and the layered clay mineral organized with the organizing agent are added to the thermoplastic resin composition comprising the polyphenylene oxide, and the layered clay mineral and the polar compound are chemically bonded to each other in the thermoplastic resin composition, whereby the thermal decomposition of the organizing agent will be suppressed well even if they are kneaded under high temperature conditions and whereby the polar compound can retain the sufficient interlayer distance of the layered clay mineral if the organizing agent is thermally decomposed. Therefore, the layered clay mineral can be adequately uniformly dispersed in the thermoplastic resin composition containing the polyphenylene oxide, so that it becomes feasible to satisfactorily enhance the characteristics of mechanical strength, durability, etc. of the resin composite material. It also becomes feasible to produce the resin composite material of the present invention with such excellent characteristics efficiently and securely by the production methods of the present invention.

### BRIEF DESCRIPTION OF THE DRAWINGS

FIG. 1 is a view showing a scanning electron micrograph (at the magnification of 450,000×) of a resin composite material of Example 1, obtained in Example 10.

FIG. 2 is graphs showing the result of elemental analysis for part 1 in FIG. 1.

FIG. 3 is graphs showing the result of elemental analysis for part 2 in FIG. 1.

FIG. 4 is a view showing a scanning electron micrograph (at the magnification of 450,000×) of a resin composite material of Example 9, obtained in Example 11.

FIG. 5 is graphs showing the result of elemental analysis for part 1 in FIG. 4.

FIG. 6 is graphs showing the result of elemental analysis for part 2 in FIG. 4.

### DESCRIPTION OF THE PREFERRED EMBODIMENTS

The preferred embodiments of the present invention will be described below in detail.

(Thermoplastic Resin Composition)

The present invention employs the thermoplastic resin composition that contains a polyphenylene oxide (poly(2,6-dimethylphenylene ether))consisting of constituent units expressed by the following general formula (1):

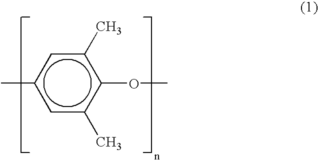

(where n is an integer).

It is preferable herein that an intrinsic viscosity [η] (at 25° C. in chloroform) of the polyphenylene oxide be preferably 0.10 to 1.5 dl/g and more preferably 0.25 to 1.0 dl/g. When the intrinsic viscosity of the polyphenylene oxide is less than the foregoing lower limit, the mechanical characteristics tend to degrade. When it exceeds the upper limit on the other hand, processability tends to degrade heavily.

Further, the thermoplastic resin composition of the invention may contain, in addition to the polyphenylene oxide, at least one compound selected from the group consisting of rubbers, thermoplastic resins, and thermoplastic elastomers. Examples of the rubbers used in the present invention include butadiene rubber, chloroprene rubber, nitrile rubber, epichlorohydrin rubber, isoprene rubber, butyl rubber, ethylene-propylene rubber, styrene-butadiene rubber, SEBS, SEPS, EPDM (ethylene propylene diene terpolymer), acrylic rubber, acrylonitrile-butadiene rubber, natural rubber, and so on; examples of the thermoplastic resins and thermoplastic elastomers include polystyrene, polyethylene, polypropylene, polyvinyl chloride, polyvinylidene chloride, fluororesin, polymethyl methacrylate, polyamide, polyester, polycarbonate, polyurethane, polyacetal, polyphenylene sulfide, polyether imide, ABS resin, and so on. Among them, it is preferable to use polystyrene, a copolymer of styrene such as high-impact polystyrene or the like, an alloy thereof, styrene-butadiene rubber, SEBS or SEPS in combination with the polyphenylene oxide, because the flowability and impact resistance tends to be improved thereby. In the combination use of the polyphenylene oxide with another thermoplastic resin, the content of the polyphenylene oxide is preferably 10 to 90% by weight, based on the total amount of the composition.

(Layered Clay Mineral)

There are no specific restrictions on the layered clay mineral according to the present invention, but the layered clay mineral can be selected, for example, from the kaolinite group consisting of kaolinite, halloysite, and so on; the smectite group consisting of montmorillonite, baidellite, saponite, hectorite, mica, and so on; the vermiculite group, and so on. These layered clay minerals can be natural substances, treated products from natural substances, or synthetic products like expansive fluorinated mica. In the present invention, one of the above layered clay minerals may be used alone, or two or more of them may be used as a mixture.

There are no specific restrictions on the total cation exchange capacity of the aforementioned layered clay mineral, either, but the total cation exchange capacity is preferably 10 to 300 meq/100 g and more preferably 50 to 200 meq/100 g. The total cation exchange capacity stated in the present invention refers to a numerical value calculated by the column operation method described hereinafter.

Namely, absorbent cotton and filter paper HV is filled in a leaching tube having the length of 12 cm and the inside diameter of 1.3 cm to make a filter layer 5 mm thick, 0.2 to 1 g of the layered clay mineral, together with quartz sand, is placed thereon, and 100 ml of 1N ammonium acetate solution is made to penetrate it for 4 to 20 hours, thereby obtaining the layered clay mineral saturated with ammonium ions.

This is washed with 100 ml of 10% saline solution to exchange and leach out ammonium ions, the content of ammonium ions is measured, and a milligram equivalent (meq) of cations per 100 g of the layered clay mineral is calculated from the thus measured value, as the total cation exchange capacity.

(Organizing agent)

In the present invention, the foregoing layered clay mineral is organized with the organizing agent and the resultant is added to the thermoplastic resin composition containing the polyphenylene oxide. The term “organization” in the present invention means that an organic substance is made to be adsorbed and/or bonded on surfaces and/or between layers of the aforementioned layered clay mineral by a physical or chemical method. The organizing agent refers to such an organic substance capable of being adsorbed and/or bonded, and is normally an organic compound consisting of an organic group and a polar group which produces ions in a solvent.

There are no specific restrictions on the type of the organizing agent used in the present invention, but it is preferable to use an organic onium compound, particularly, in terms of superiority in reactivity with the layered clay mineral. The organic onium compound can be either of organic ammonium compounds, organic phosphonium compounds, organic pyridinium compounds, organic sulfonium compounds, and so on, among which the organic ammonium compounds and organic phosphonium compounds are preferably used, because organic onium ions produced therefrom demonstrate good reactivity.

There are no specific restrictions on the number of carbons in an organic group bonded to an atom having lone-pair electrons (e.g., a nitrogen atom in the organic ammonium compounds) in the foregoing organic onium compound, but the number of carbons in an organic group of the longest chain is preferably 4 to 30 and more preferably 6 to 24. When the number of carbons in the longest chain is less than 4, the effect of the organization of the layered clay mineral tends to be inadequate. When it exceeds 30, the dispersion of the layered clay mineral in the polymer tends to become inadequate. The number of organic groups bonded to the atom having lone-pair electrons in the foregoing organic onium compound is not less than one nor more than a maximum number that is determined by the number of bonds permitted. Each organic group may have a substituent such as a carboxyl group, a hydroxyl group, a thiol group, a nitrile group, or the like.

The organic ammonium compounds used as the organizing agent according to the present invention, can include primary, secondary, tertiary, and quaternary organic ammonium compounds. Specific examples of such ammonium compounds include hexyl ammonium compounds, octyl ammonium compounds, decyl ammonium compounds, dodecyl ammonium compounds, tetradecyl ammonium compounds, hexadecyl ammonium compounds, octadecyl ammonium compounds, hexyltrimethyl ammonium compounds, octyltrimethyl ammonium compounds, decyltrimethyl ammonium compounds, dodecyltrimethyl ammonium compounds, tetradecyltrimethyl ammonium compounds, hexadecyltrimethyl ammonium compounds, octadecyltrimethyl ammonium compounds, dodecyldimethyl ammonium compounds, dodecylmethyl ammonium compounds, dioctadecyl ammonium compounds, dioctadecyldimethyl ammonium compounds, benzyldimethyloctadecyl ammonium compounds, and so on. One of the aforementioned organic ammonium compounds may be used alone, or two or more compounds may be used in combination, in the present invention.

In the present invention, the organization of the layered clay mineral can be implemented, for example, by the method disclosed in Japanese Patent No. 2627194 of Applicant of the present application. Namely, it can be implemented by ion exchange of exchanging inorganic ions such as sodium ions or the like in the layered clay mineral with organic onium ions evolving from the foregoing organic onium compound (e.g., organic ammonium ions in the case of the organic ammonium compounds). When an organic ammonium compound is used as the organic onium compound, the organization can be effected by the following method. Namely, when the layered clay mineral is a bulk, it is first pulverized into powder by a ball mill or the like. Then this powder is dispersed in water with a mixer or the like to obtain an aqueous dispersion of the layered clay mineral. Separately therefrom, an acid such as hydrochloric acid, and an organic amine are added into water to prepare an aqueous solution of an organic ammonium compound, and this aqueous solution is mixed into the foregoing aqueous dispersion of the layered clay mineral, thereby effecting the ion exchange to exchange the inorganic cations in the layered clay mineral with the organic ammonium ions. Then water is removed from this mixture to obtain the layered clay mineral organized with the organizing agent (organic ammonium compound). The dispersion medium for the organic ammonium compound and the layered clay mineral can also be selected from methanol, ethanol, propanol, isopropanol, ethylene glycol, mixtures thereof with each other, and mixtures thereof with water, and so on, as well as water.

(Polar compound)

There are no specific restrictions on the polar compound according to the present invention as long as it can be chemically bonded to the layered clay mineral. Specific examples of the polar compound include phosphate compounds, hindered phenols, aromatic amines, and so on. Among these, it is preferable to use the phosphate compounds, because the dispersibility of the layered clay mineral is improved better thereby, so as to tend to enhance the mechanical strength and durability of the resin composite material further. The chemical bond between the layered clay mineral and the polar compound can be either of a covalent bond, an ion bond, a hydrogen bond, and so on.

Examples of the phosphate compounds used in the present invention include the following compounds:

phosphates such as tributyl phosphate, tripentyl phosphate, trihexyl phosphate, triheptyl phosphate, trioctyl phosphate, trinonyl phosphate, tridecyl phosphate, triundecyl phosphate, tridodecyl phosphate, tritridecyl phosphate, tritetradecyl phosphate, tripentadecyl phosphate, trihexadecyl phosphate, triheptadecyl phosphate, trioctadecyl phosphate, trioleyl phosphate, triphenyl phosphate, tricresyl phosphate, trixylenyl phosphate, cresyldiphenyl phosphate, xylenyldiphenyl phosphate, and so on;

acidic phosphates such as monobutyl acid phosphate, monopentyl acid phosphate, monohexyl acid phosphate, monoheptyl acid phosphate, monooctyl acid phosphate, monononyl acid phosphate, monodecyl acid phosphate, monoundecyl acid phosphate, monododecyl acid phosphate, monotridecyl acid phosphate, monotetradecyl acid phosphate, monopentadecyl acid phosphate, monohexadecyl acid phosphate, monoheptadecyl acid phosphate, monooctadecyl acid phosphate, monooleyl acid phosphate, dibutyl acid phosphate, dipentyl acid phosphate, dihexyl acid phosphate, diheptyl acid phosphate, dioctyl acid phosphate, dinonyl acid phosphate, didecyl acid phosphate, diundecyl acid phosphate, didodecyl acid phosphate, ditridecyl acid phosphate, ditetradecyl acid phosphate, dipentadecyl acid phosphate, dihexadecyl acid phosphate, diheptadecyl acid phosphate, dioctadecyl acid phosphate, dioleyl acid phosphate, and so on;

phosphites such as dibutyl phosphite, dipentyl phosphite, dihexyl phosphite, diheptyl phosphite, dioctyl phosphite, dinonyl phosphite, didecyl phosphite, diundecyl phosphite, didodecyl phosphite, dioleyl phosphite, diphenyl phosphite, dicresyl phosphite, tributyl phosphite, tripentyl phosphite, trihexyl phosphite, triheptyl phosphite, trioctyl phosphite, trinonyl phosphite, tridecyl phosphite, triundecyl phosphite, tridodecyl phosphite, trioleyl phosphite, triphenyl phosphite, tricresyl phosphite, and so on. Among them, it is particularly preferable to use the phosphites, because the dispersivility of the layered clay mineral tends to be improved better thereby and because the mechanical strength and durability of the resin composite material is enhanced further. Here one of these phosphate compounds may be used alone, or two or more compounds may be used in combination.

The content of the polar compound according to the present invention is preferably 0.01 to 10% by weight, based on the total amount of the resin composite material. When the content of the polar compound is less than the lower limit, it becomes harder to retain the sufficient interlayer distance of the layered clay mineral during the kneading under high temperature conditions, so that the layered clay mineral cannot be satisfactorily uniformly dispersed whereby the mechanical strength and durability of the resin composite tends to become inadequate. When the content of the polar compound exceeds the upper limit on the other hand, the polar compound becomes easier to bleed out during processing of the resultant resin composite material, so as to tend to contaminate molded products and dies readily.

In the present invention, the resin composite material may contain an additive such as a pigment, a heat stabilizer, a flame retardant, an antioxidant, a weatherability enhancing agent, a mold releasing agent, a plasticizer, a reinforcing agent, or the like, in addition to the resin composition containing the polyphenylene oxide, the layered clay mineral organized with the organizing agent, and the polar compound, as long as the additive does not heavily degrade the characteristics of the resin composite material.

The present invention enables the thermoplastic resin composition containing the polyphenylene oxide to intrude (or intercalate) into between layers of the layered clay mineral, which increases the interlayer distance of the layered clay mineral. The interlayer distance at this time is preferably 10 Å or more wider, more preferably 30 Å or more wider, and still more preferably 100 Å or more wider than that before occurrence of the intercalation. The interlayer distance is most preferably widened up to a level at which the layer structure of the layered clay mineral vanishes. It is more preferable to widen all the interlayer distances of the layered clay mineral by 30 Å or more (more preferably, 100 Å or more), but the foregoing condition does not always have to be met by all the interlayer distances of the layered clay mineral for a manufacturing reason.

The interlayer distance of the layered clay mineral can be measured by X-ray diffraction, and the increase in the interlayer distance can be confirmed by appearance of a peak in a smaller diffraction angle region in an X-ray diffraction pattern. It is also possible to confirm loss of regularity of the layer structure from obscurity of the peak or disappearance of the peak. The state of dispersion of the layered clay mineral can also be indirectly checked from viscosity. Namely, the resin composite material with the layered clay mineral finely being dispersed therein has the viscosity (melt viscosity or the like) much greater than that of the material containing no layered clay mineral, whereas a polymer composition containing the layered clay mineral in a worse dispersed state demonstrates only a small increase of viscosity.

(Production Method of Resin Composite Material)

In a first production method of the resin composite material according to the present invention, the polar compound is first made to be dispersed in the thermoplastic resin composition containing the polyphenylene oxide, thereby obtaining a mixture of the thermoplastic resin composition and the polar compound.

There are no specific restrictions on how to disperse the polar compound in the thermoplastic resin composition containing the polyphenylene oxide, but it can be made to be dispersed, for example, by a melt kneading method. The melt kneading method is a method of obtaining the mixture by heating the thermoplastic resin composition containing the polyphenylene oxide, and the polar compound to a temperature not less than the melting point or softening point of the resin composition and mixing them. Specifically, the melt kneading method is a method of kneading them under heat in a kneader such as a twin screw extruder, a single screw extruder, a batch mixer, a laboratory blasting mill, or the like. During the heating step, it is preferable to apply a shearing force to the mixture so as to disperse the polar compound uniformly. It is also preferable to use a twin screw extruder as a means for applying the shearing force while applying heat.

The mixture can also be yielded by a method of dispersing or dissolving the thermoplastic resin composition containing the polyphenylene oxide, and the polar compound in a solvent such as water, an organic solvent, or the like, agitating the solution, and thereafter removing the solvent.

The mixture can also be yielded by other methods than the aforementioned methods; for example, a potential method is a method of adding the polar compound to a source monomer for the thermoplastic resin composition and polymerizing the monomer in the presence of the polar compound.

There are no specific restrictions on a compounding ratio of the thermoplastic resin composition and the polar compound, but it is preferable to employ such a compounding ratio that a compounding amount of the polar compound becomes 0.01 to 10 parts by weight (more preferably, 0.05 to 5 parts by weight), based on the total amount of the resultant resin composite material. When the compounding amount of the polar compound is less than the lower limit, the dynamic characteristics of the resultant resin composite material tend to become inadequate. When it exceeds the upper limit on the other hand, the polar compound becomes easier to bleed out during processing of the resultant resin composite material, so as to tend to contaminate the molded products and dies readily.

In the next place, the layered clay mineral organized with the organizing agent is made to be dispersed in the foregoing mixture, thereby obtaining the resin composite material of the present invention.

There are no specific restrictions on a method of dispersing the layered clay mineral organized with the organizing agent, in the mixture. For example, the layered clay mineral can be made to be dispersed in the mixture by a method similar to the aforementioned method of mixing the thermoplastic resin composition and the polar compound.

A compounding amount of the layered clay mineral organized with the organizing agent is preferably 0.01 to 200 parts by weight, more preferably 0.1 to 100 parts by weight, and still more preferably 0.1 to 30 parts by weight per 100 parts by weight of the thermoplastic resin composition containing the polyphenylene oxide in the mixture. When the compounding amount of the layered clay mineral is less than 0.01 part by weight, the dynamic characteristics of the resultant resin composite material tend to become inadequate. When it exceeds 200 parts by weight on the other hand, the thermoplastic resin composition tends to fail to form a continuous layer, the dynamic characteristics of the resin composite material degrade, and the viscosity becomes so high as to tend to degrade processability.

In a second production method of the resin composite material according to the present invention, the layered clay mineral organized with the organizing agent, and the polar compound are first mixed with each other, thereby obtaining a complex in which the organizing agent and the polar compound are chemically bonded to each other between layers of the layered clay mineral.

There are no specific restrictions on a method of mixing the organized, layered clay mineral and the polar compound as long as the layered clay mineral and the polar compound can chemically be bonded thereby to each other between layers of the layered clay mineral. However, the temperature during mixing is preferably 0 to 350° C.

There are no specific restrictions on a compounding ratio of the organized, layered clay mineral and the polar compound, but it is preferable to employ such a compounding ratio that a compounding amount of the polar compound becomes 0.01 to 10 parts by weight (more preferably, 0.05 to 5 parts by weight), based on the total amount of the resultant resin composite material. When the compounding amount of the polar compound is less than the lower limit, the dispersion of the layered clay mineral becomes inadequate, so that the dynamic characteristics of the resultant resin composite material tend to become inadequate. When it exceeds the upper limit on the other hand, the polar compound becomes easier to bleed out during processing of the resultant resin composite material, so as to tend to contaminate the molded products and dies readily.

Then the foregoing complex is made to be dispersed in the thermoplastic resin composition containing the polyphenylene oxide, thereby obtaining the resin composite material of the present invention.

There are no specific restrictions on a method of dispersing the complex in the thermoplastic resin composition as long as the complex can be made to be satisfactorily uniformly dispersed in the thermoplastic resin composition. For example, the dispersion can be suitably implemented by the melt kneading method exemplified in the description of the foregoing first production method.

A compounding ratio of the thermoplastic resin composition containing the polyphenylene oxide, and the complex is determined so that a compounding amount of the latter is preferably 0.01 to 100 parts by weight and more preferably 0.5 to 30 parts by weight per 100 parts by weight of the former. When the compounding amount of the complex is less than 0.01 part by weight, the dynamic characteristics of the resultant resin composite material tend to become inadequate. When it exceeds 100 parts by weight on the other hand, the thermoplastic resin composition tends to fail to form a continuous layer, the dynamic characteristics of the resin composite material degrade, and the viscosity becomes so high as to tend to degrade processability.

Further, the resin composite material of the present invention can also be yielded by a third production method, i.e., by a method of dispersing the layered clay mineral organized with the organizing agent, in the thermoplastic resin composition containing the polyphenylene oxide to obtain a mixture of the thermoplastic resin composition and the layered clay mineral, and thereafter further dispersing the polar compound in the mixture.

Moreover, the resin composite material of the present invention can also be yeilded by a fourth production method, i.e., by a method of mixing the thermoplastic resin composition containing the polyphenylene oxide, the layered clay mineral organized with the organizing agent, and the polar compound.

As described above, the present invention employs the polar compound capable of being chemically bonded to the layered clay mineral between layers or on external surfaces of the layered clay mineral, whereby the layered clay mineral can be finely dispersed in the thermoplastic resin containing the polyphenylene oxide even after the kneading under high temperature conditions. Since the dispersion of the layered clay mineral being fine means that the contact area is large between the layered clay mineral and the thermoplastic resin composition, it increases the rate of the thermoplastic resin composition restrained by the layered clay mineral, which results in improvement in the dynamic characteristics such as the mechanical strength, durability, etc. of the resultant resin composite material. For this reason, the resin composite material of the present invention can be used, for example, in the fields requiring high dynamic characteristics. Since the resin composite material of the present invention is also excellent in a gas barrier property, it can also be suitably used in the fields where the gas barrier property is particularly important, e.g., coating materials, packaging materials, and so on.

### EXAMPLES

The present invention will be described below in more detail on the basis of examples and comparative examples, but it is noted that the present invention is by no means intended to be limited to the examples below.

### Example 1

First, a polyphenylene oxide (intrinsic viscosity [η]: 0.46) and a high-impact polystyrene resin S (weight-average molecular weight: 230,000) were mixed at a mixing ratio of 6:4 to obtain a thermoplastic resin composition. 2 g of tridecyl phosphite was added to 100 g of the thermoplastic resin composition and they were melted and kneaded in a twin screw extruder to obtain a mixture (the content of tridecyl phosphite: 2% by weight). The resin temperature during the kneading was 280° C.

Then 100 g of sodium montmorillonite (a layered clay compound available from Kunimine Kogyo K.K., trade name: Kunipia F, the total cation exchange capacity: 119 meq/100 g) was dispersed in 6500 ml of water at 80° C. Added into this montmorillonite-dispersed solution was a solution in which 38.5 g of octadecyl amine and 14.5 ml of concentrated hydrochloric acid were dissolved in 2500 ml of water at 80° C., which yielded a sediment. This sediment was filtered, washed three times with water at 80° C., and freeze-dried to obtain the layered clay mineral organized.

Further, the organized, layered clay mineral was added into the foregoing mixture and they were mixed by the melt kneading method, thereby obtaining an objective resin composite material containing 7% by weight of the organized, layered clay mineral.

A strand of the resultant resin composite material was water-cooled, cut into resin pellets, further dried at 80° C. under vacuum, and used in the following tensile test, fatigue life test, and X-ray diffractometry.

For the tensile test, the resultant resin composite material was molded into a dumbbell test piece by an injection molding machine, and the test was conducted according to the method defined in ASTM-D-638 to determine a tensile strength, a tensile elastic modulus, and an elongation at break. The results are presented in Table 1.

For the fatigue life test, the resultant resin composite material was first molded into a flat sheet of 100 mm×150 mm×1 mm by the injection molding machine, and a test piece of 2 mm wide×50 mm long was cut out of the flat sheet. This test piece was subjected to tension and compression cycles under strain of 2%, and a fatigue life was determined as the number of tension and compression cycles at a break of the test piece. The results are presented in Table 1. The test temperature was 25° C.

For the X-ray diffractometry, the test piece cut out of the flat sheet, which was used in the above fatigue life test, was used to determine presence/absence of a diffraction peak, and a position of a diffraction peak if present. The results obtained are presented in Table 1.

### Example 2

A resin composite material was prepared in much the same manner as in Example 1 except that triphenyl phosphite was used instead of tridecyl phosphite in Example 1, and the tensile test, fatigue life test, and X-ray diffractometry were carried out using it. The results obtained are presented in Table 1.

### Example 3

A resin composite material was prepared in much the same manner as in Example 1 except that the content i 15 of tridecyl phosphite was 0.05% by weight, and the tensile test, fatigue life test, and X-ray diffractometry were carried out using it. The results obtained are presented in Table 1.

### Example 4

A resin composite material was prepared in much the same manner as in Example 1 except that the mixing ratio of the polyphenylene oxide and high-impact polystyrene was 8:2, and the tensile test, fatigue life test, and X-ray diffractometry were carried out using it. The results obtained are presented in Table 1.

### Example 5

A resin composite material was prepared in much the same manner as in Example 1 except that the mixing ratio of the polyphenylene oxide and high-impact polystyrene was 3:7, and the tensile test, fatigue life test, and X-ray diffractometry were carried out using it. The results obtained are presented in Table 1.

### Example 6

A resin composite material was prepared in much the same manner as in Example 1 except that a polystyrene resin (weight-average molecular weight: 230,000) was used instead of the high-impact polystyrene resin in Example 1, and the tensile test, fatigue life test, and X-ray diffractometry were carried out using it. The results obtained are presented in Table 1.

### Example 7

A resin composite material was prepared in much the same manner as in Example 1 except that the layered clay mineral organized was dispersed in the polyphenylene oxide, without using the high-impact polystyrene resin, and the tensile test, fatigue life test, and X-ray diffractometry were carried out using it. The results obtained are presented in Table 1.

### Example 8

A resin composite material was prepared in much the same manner as in Example 1 except that an expansive, synthetic mica organized with dodecyl amine (the content of dodecyl amine: 20% by weight) was used instead of the montmorillonite organized with octadecyl amine, and the tensile test, fatigue life test, and X-ray diffractometry were carried out using it. The results obtained are presented in Table 1.

### Example 9

100 g of the organized, layered clay mineral obtained in much the same manner as in Example 1 (the montmorillonite organized with octadecyl amine), and 35 g of tridecyl phosphite were mixed and heated at 80° C. The interlayer distance of the organized montmorillonite was 23 Å, whereas the interlayer distance of the montmorillonite in the resultant mixture was 32 Å. This verifies that an intercalation compound was formed between the layered clay mineral and tridecyl phosphite between layers or on external surfaces of the montmorillonite.

Then 10 g of the resultant mixture was added into the thermoplastic resin composition similar to that in Example 1, and they were kneaded to obtain a resin composite material. The tensile test, fatigue life test, and X-ray diffractometry were carried out using it. The results obtained are presented in Table 1.

### Comparative Example 1

A resin composite material was prepared in much the same manner as in Example 1 except that tridecyl phosphite was not used, and the tensile test, fatigue life test, and X-ray diffractometry were carried out using it. The results obtained are presented in Table 1.

### Comparative Example 2

A resin composite material was prepared in much the same manner as in Example 4 except that tridecyl phosphite was not used, and the tensile test, fatigue life test, and X-ray diffractometry were carried out using it. The results obtained are presented in Table 1.

### Comparative Example 3

A resin composite material was prepared in much the same manner as in Example 5 except that tridecyl phosphite was not used, and the tensile test, fatigue life test, and X-ray diffractometry were carried out using it. The results obtained are presented in Table 1.

### Comparative Example 4

A resin composite material was prepared in much the same manner as in Example 6 except that tridecyl phosphite was not used, and the X-ray diffractometry was carried out using it. The result obtained is presented in Table 1.

### Comparative Example 5

A resin composite material was prepared in much the same manner as in Example 7 except that tridecyl phosphite was not used, and the X-ray diffractometry was carried out using it. The result obtained is presented in Table 1.

### Comparative Example 6

A resin composite material was prepared in much the same manner as in Example 8 except that tridecyl phosphite was not used, and the tensile test, fatigue life test, and X-ray diffractometry were carried out using it. The results obtained are presented in Table 1.

TABLE 1

| | Tensile test | | | | | |
|---|---|---|---|---|---|---|
| | | Tensile | | Fatigue | X-ray diffractometry | |
| | | elastic | Elon- | life test | Existence | |
| | Tensile | modu- | gation | Fatigue | of | Peak |
| | strength | lus | at break | life | diffraction | Position |
| | [MPa] | [GPa] | [%] | [cycles] | peak | (2 θ [°]) |
| Example 1 | 50 | 3.10 | 10 | 8000 | no | — |
| Example 2 | 51 | 3.15 | 11 | 8500 | no | — |
| Example 3 | 48 | 3.05 | 9 | 7500 | no | — |
| Example 4 | 55 | 3.20 | 3 | 7500 | no | — |
| Example 5 | 45 | 2.80 | 12 | 7500 | no | — |
| Example 6 | — | — | — | — | no | — |
| Example 7 | — | — | — | — | no | — |
| Example 8 | 49 | 2.90 | 10 | 7800 | no | — |
| Example 9 | 51 | 3.10 | 10 | 8500 | no | — |
| Comparative | 40 | 2.10 | 1 | 5000 | yes | 2.5 |
| Example 1 | | | | | | |
| Comparative | 45 | 2.10 | 0.5 | 4000 | yes | 2.2 |
| Example 2 | | | | | | |
| Comparative | 38 | 2.00 | 2 | 4000 | yes | 2.8 |
| Example 3 | | | | | | |
| Comparative | — | — | — | — | yes | 2.5 |
| Example 4 | | | | | | |
| Comparative | — | — | — | — | yes | 5.9 |
| Example 5 | | | | | | |
| Comparative | 40 | 2.00 | 1 | 4900 | yes | 2.5 |
| Example 6 | | | | | | |

As seen from Table 1, there was no diffraction peak detected in the X-ray diffraction spectra in the case of the resin composite materials of Examples 1 to 9, and it was thus verified that the interlayer distance of the layered clay mineral was satisfactorily large and that the layered clay mineral was satisfactorily uniformly dispersed. Each of these resin composite materials demonstrated the sufficiently high mechanical strength and durability in the tensile test and the fatigue life test.

In contrast to it, there existed a diffraction peak in the X-ray diffraction spectra in the case of the resin composite materials of Comparative Examples 1 to 6, and it was thus confirmed that the dispersibility of the layered clay mineral was inadequate. In addition, each of the resin composite materials of Comparative Examples 1 to 3, and 6 exhibited the inadequate mechanical strength and durability in the tensile test and the fatigue life test.

### Example 10

The resin composite material of Example 1 was subjected to observation with a transmission electron microscope and to elemental analysis with focus on phosphorus (P) in tridecyl phosphite in accordance with the following procedures. The observation and analysis was carried out using the transmission electron microscope (HD-2000 available from Hitachi, Ltd.) provided with an element analyzer (VANTAGE(EDX) available from NPRAN).

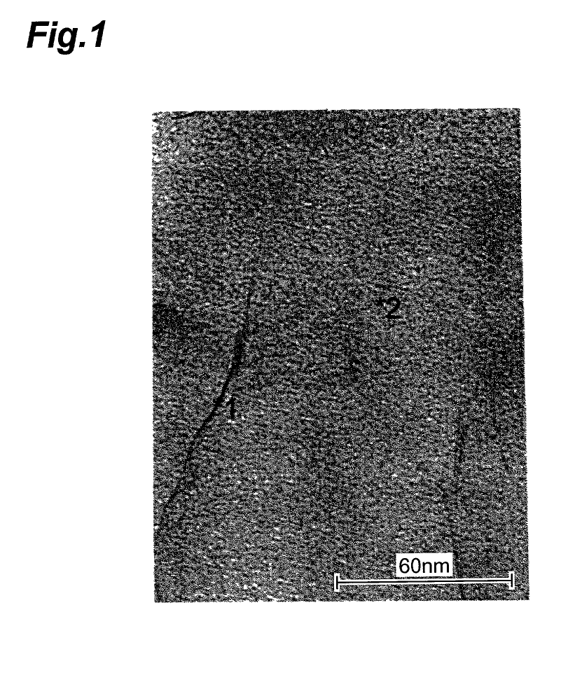

First, the resin composite material was observed with the transmission electron microscope at the acceleration voltage of 200 kV and at the observation magnification of 450,000×. An electron micrograph obtained is presented in FIG. 1. As seen from FIG. 1, it was confirmed that unit layers of the layered clay mineral were dispersed in fibrous form in the resin composite material of Example 1.

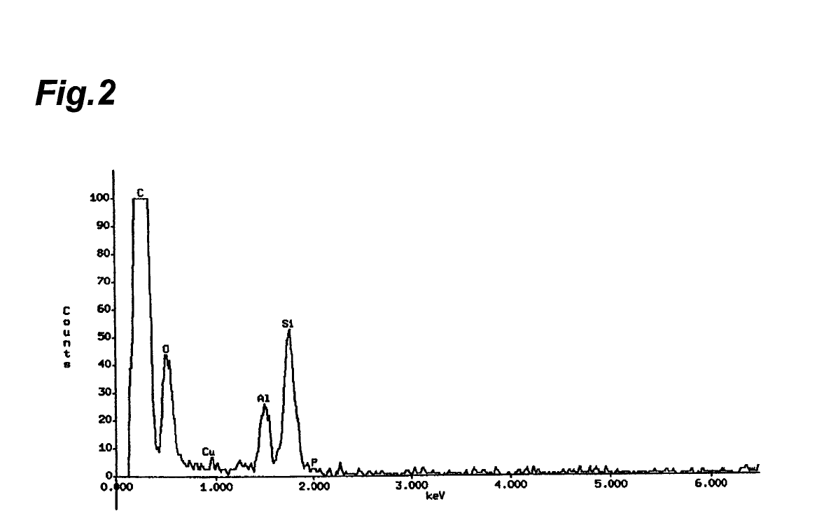

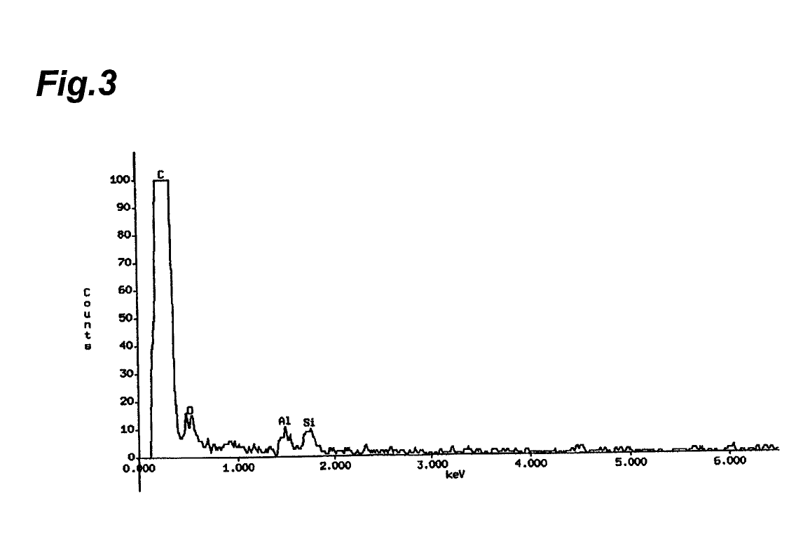

In the next place, the elemental analysis was conducted by energy-dispersive X-ray spectrometry (EDX method) at the acceleration voltage of 200 kV, using an X-ray detector (Si/Li semiconductor detector), for each of a part of the layers of the layered clay mineral dispersed (part 1 in FIG. 1) and a part of the resin without dispersion of the clay mineral (part 2 in FIG. 1). The results of the analysis for the respective parts are presented in FIG. 2 and FIG. 3.

Detected at the part of the layers of the layered clay mineral dispersed, as shown in FIG. 2, were carbon (C) and oxygen (O) originating from the resin (polyphenylene ether and high-impact polystyrene), aluminum (Al) and silicon (Si) originating from the layered clay mineral, and phosphorus (P) originating from tridecyl phosphite. FIG. 2 also shows a detection peak of copper (Cu), and it originates from a copper support film for supporting the observed sample.

At the part of the resin without dispersion of the clay mineral on the other hand, C and O were detected with strong peak intensity, but P was not detected, as shown in FIG. 3. Al and Si were also detected with weak peak intensity, and the inventors speculate that they were detected because of the clay mineral dispersed in surroundings.

The above results prove that tridecyl phosphite was concentrated near the layers of the layered clay mineral during the dispersion of the layered clay mineral in Example 1 in which tridecyl phosphite was preliminarily kneaded in the resin and in which the organized, layered clay mineral [composition formula: (Na, Ca)_{0.33}(Al, Mg)₂Si₄₀₁₀(OH)₂.nH₂O] was melt-kneaded and dispersed in the mixture, and indicate that chemical bonds are formed between tridecyl phosphite and the layered clay mineral dispersed in the resin.

### Example 11

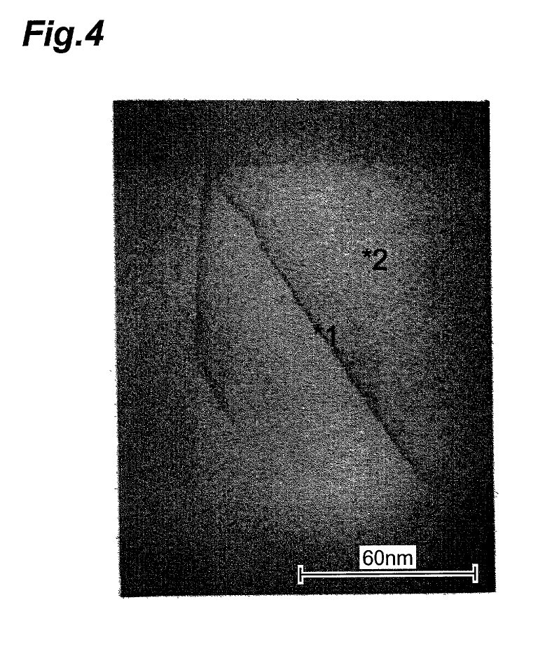

The resin composite material of Example 9 was first subjected to the observation with the transmission electron microscope in much the same manner as in Example 10. An electron micrograph obtained is presented in FIG. 4.

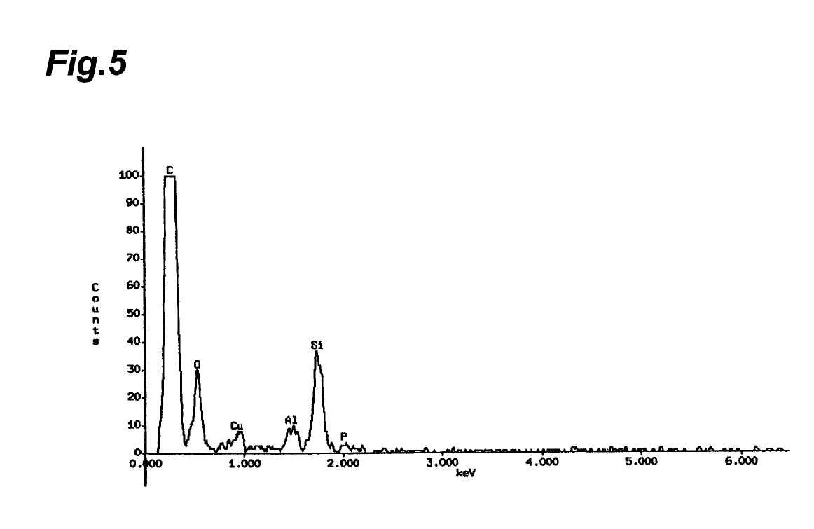

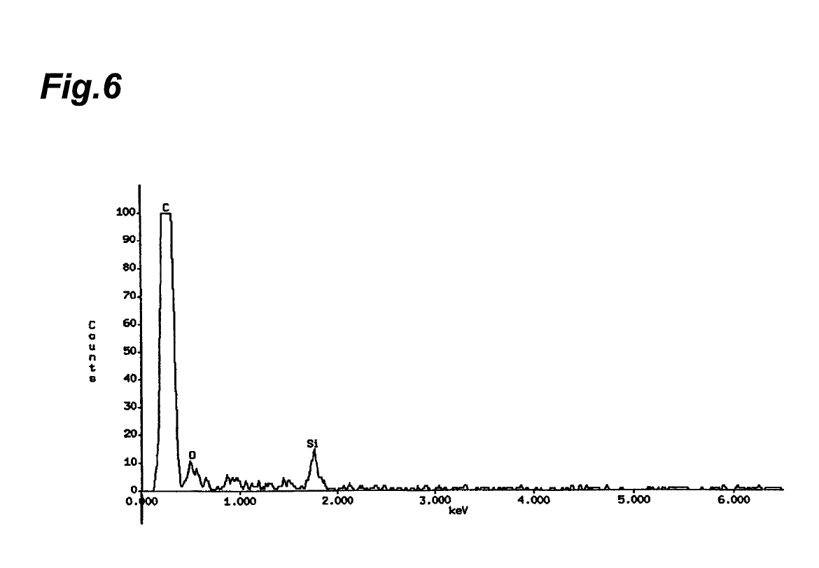

In the next place, the elemental analysis was conducted in much the same manner as in Example 10, for each of a part of the layers of the layered clay mineral dispersed (part 1 in FIG. 4) and a part of the resin without dispersion of the clay mineral (part 2 in FIG. 4). The results of the analysis for the respective parts are presented in FIG. 5 and FIG. 6.

Detected at the part of the layers of the layered clay mineral dispersed, as shown in FIG. 5, were C and O originating from the resin (polyphenylene ether and high-impact polystyrene), Al and Si originating from the layered clay mineral, and P originating from tridecyl phosphite. FIG. 5 also shows a detection peak of Cu, and it originates from the copper support film for supporting the observed sample.

At the part of the resin without dispersion of the clay mineral on the other hand, C and O were detected with strong peak intensity, but P was not detected, as shown in FIG. 6. Al and Si were also detected with weak peak intensity, and the inventors speculate that they were detected because of the clay mineral dispersed in surroundings.

The above results prove that, in Example 9 in which tridecyl phosphite was brought into contact with the organized, layered clay mineral [composition formula: (Na, Ca)_{0.33}(Al, Mg)₂Si₄₀₁₀(OH)₂.nH₂O] to prepare a complex (intercalation compound) of the two materials and in which the complex was melt-kneaded and dispersed in the resin, tridecyl phosphite was dispersed in the resin while being bonded to the layered clay mineral without being separated from the complex during the dispersion of the complex, and indicate that the layered clay mineral and tridecyl phosphite dispersed in the resin are strongly bonded to each other.

In the resin composite materials according to the present invention, as detailed above, the layered clay mineral is satisfactorily uniformly dispersed in the thermoplastic resin composition even after the kneading under high temperature conditions, which makes it feasible to achieve the satisfactorily high mechanical strength and satisfactorily high durability. The production methods of the present invention also make it feasible to yield the resin composite materials of the present invention efficiently and securely.

What is claimed is:

1. A resin composite material comprising:
a thermoplastic resin composition comprising a polyphenylene oxide;
a layered clay mineral dispersed in said thermoplastic resin composition and organized with an organizing agent; and
a polar compound dispersed in said thermoplastic resin composition and chemically bonded to said layered clay mineral.

2. The resin composite material according to claim 1, wherein said polar compound is a phosphate compound.

3. The resin composite material according to claim 1, wherein said polar compound is a phosphite.

4. A method of producing a resin composite material comprising: a thermoplastic resin composition comprising a polyphenylene oxide; a layered clay mineral dispersed in said thermoplastic resin composition and organized with an organizing agent; and a polar compound dispersed in said thermoplastic resin composition and chemically bonded to said layered clay mineral, said method comprising:
a step of dispersing the polar compound in the thermoplastic resin composition comprising the polyphenylene oxide, thereby obtaining a mixture of said thermoplastic resin composition and said polar compound; and
a step of dispersing the layered clay mineral organized with the organizing agent, in said mixture, thereby obtaining said resin composite material.

5. A method of producing a resin composite material comprising: a thermoplastic resin composition comprising a polyphenylene oxide; a layered clay mineral dispersed in said thermoplastic resin composition and organized with an organizing agent; and a polar compound dispersed in said thermoplastic resin composition and chemically bonded to said layered clay mineral, said method comprising:
a step of mixing the layered clay mineral organized with the organizing agent, and the polar compound, thereby obtaining a complex in which said layered clay mineral and said polar compound are chemically bonded to each other between layers of said layered clay mineral; and
a step of dispersing said complex in the thermoplastic resin composition comprising the polyphenylene oxide, thereby obtaining said resin composite material.
